(19) United States
(12) Patent Application Publication
(10) Pub. No.: US 2025/0289688 A1
(43) Pub. Date: Sep. 18, 2025

(54) Device for Documenting a Construction Site

(71) Applicant: Liebherr-Werk Biberach GmbH, Biberach an der Riss (DE)

(72) Inventors: Michael Kreger, Schemmerhofen (DE); Robert Bramberger, Reinstetten (DE); Benjamin Gralla, Achstetten (DE)

(21) Appl. No.: 18/859,822

(22) PCT Filed: Apr. 24, 2023
(86) PCT No.: PCT/EP2023/060690

§ 371 Date: Nov. 17, 2024

(30) Foreign Application Priority Data
Apr. 26, 2022 (DE) 10 2022 110 040.5

(51) Int. Cl. B66C 13/46; G06Q 50/08; G06V 20/52

(52) U.S. Cl. CPC B66C 13/46; G06Q 50/08; G06V 20/52

(57) ABSTRACT

The present invention relates to a device for documenting a construction site with at least one crane, with a sensor system for detecting construction site information which has at least one imaging sensor unit mounted on the crane for detecting images of the construction site, a crane state determination device for determining crane states, and an electronic computing unit for processing the detected construction site images and the determined crane states, the computing unit having a tuple device for determining context-sensitive tuples from the detected construction site images and the determined crane states.

### CROSS-REFERENCE TO RELATED APPLICATIONS

This application is a National Stage of International Application No. PCT/EP2023/060690 filed 24 Apr. 2023, which claims benefit under 35 USC § 365 of DE Application No. 10 2022 110 040.5 filed 26 Apr. 2022, each of which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a device for documenting a construction site with at least one crane, with a sensor system for detecting construction site information, which has at least one imaging sensor unit mounted on the crane for detecting images of the construction site, a crane state determination device for determining crane states, and an electronic computing unit for processing the detected construction site images and the determined crane states.

### 2. Description of Related Art

The construction processes that take place at a construction site are diverse and complex and are usually characterized by the fact that many manufacturing and logistics processes usually descend in parallel and take place in a very limited space. It is often very difficult to gain an overview of the total construction processes, as the people responsible for documenting and recording the current status are regularly only able to observe individual processes to a limited extent and locally. Comprehensive and continuous documenting the construction processes occurring at a construction site and recording the actual status of the construction site for control tasks is generally hardly possible.

Up to now, attempts have been made to document the construction site processes manually in a construction diary, usually on a daily basis, in order to have at least a rough overview and to be able to look things up for control tasks. In this case, photo applications for mobile devices are sometimes used to compile the day's events, making it possible to accommodate individual images of the construction site, annotate them accordingly and save them in a project context. However, the maintenance effort for updating such photo applications is considerable. As a rule, the results remain fragmented, wherein unnecessary additional work or duplication of work is also caused by several parties involved in the construction site.

In view of the above, it is an underlying object of the present invention to provide an improved device, system and method for documenting a construction site which avoid the disadvantages of the prior art and develop the latter in an advantageous manner. In particular, an aim is to enable the construction site processes and situation to be recorded as holistically as possible in a simple manner and to make them available to various parties involved in the construction site in a coordinated manner.

### BRIEF SUMMARY OF THE INVENTION

In an exemplary embodiment, the present invention is a device for documenting a construction site with at least one crane, with a sensor system for detecting construction site information, which has at least one imaging sensor unit mounted on the crane for detecting images of the construction site, a crane state determination device for determining crane states, and an electronic computing unit for processing the detected construction site images and the determined crane states, wherein the computing unit comprises a tuple device for determining and providing context-sensitive tuples for construction site documentation from the detected construction site images and the determined crane states.

The present invention uses the exposed position of a crane on the construction site and the views of the construction site possible from the crane to enable a comprehensive recording of the construction site situation. In this case, the actual situation is ensured by means of the wide range of information that can be provided by at least one imaging sensor unit and the crane's status data.

According to the invention, the construction site images, which have been detected by the at least one imaging sensor unit mounted on the crane, and the determined crane status data are processed by a tuple device to form context-sensitive tuples and made available to other data processing devices via at least one interface of the computing unit.

The tuple device is configured to continuously or cyclically consolidate the image data provided by the imaging sensor unit and the crane status data provided by the crane status determination device, or also triggered by a trigger, and to provide them as context-sensitive tuples for further use. Such context-sensitive tuples form an ordered collection of values in the form of data records in which the construction site images provided or streamed by the imaging sensor unit and the cyclically provided or continuously streamed crane status data are stored together in a list that preferably cannot be subsequently changed.

The crane status data can advantageously be provided as telemetry data by the crane controller, as the electronic crane controller knows at least some of the crane status data of interest. Modern cranes usually have a comprehensive sensor system with various sensors that detect different crane states and make them available to the electronic crane controller. The crane state determination device can retrieve all telemetry data or a section of the telemetry data of interest from the crane controller via a telemetry data module and/or receive telemetry data provided by the crane controller and filter out the crane state data of interest or determine it from the transmitted telemetry data in order to determine the crane states of interest for tuple formation.

However, if the telemetry data from the crane controller is incomplete or if the crane controller does not have a suitable interface for transmitting the telemetry data, the crane states of interest can also be detected by sensors, wherein a mixed acquisition of the crane states of interest can also take place, i.e. some of the crane states can be determined by the crane controller from the telemetry data received and the missing remaining part of the crane states of interest can be detected by sensors using a crane state sensor system.

Various parameters characterizing the crane state can be detected or determined as crane states, wherein in particular position and/or alignment data of one or more crane elements can be helpful in order to be able to classify the construction site images detected by the imaging sensor unit in a context-sensitive manner or to be able to determine in a simple manner in which areas of the construction site the crane has been working and the corresponding construction site images have been provided by the imaging sensor unit.

In order to be able to determine the position and/or orientation of one or more crane elements, the telemetry data module can filter out and/or process and/or retrieve position and/or orientation-relevant telemetry data for determining the position and/or orientation from the crane controller. For example, the electronic crane controller usually knows the lowering depth of the load hook and/or the position of the trolley on the jib and/or the slewing gear position and thus the alignment of the jib about the upright slewing gear axis, so that the electronic crane controller can provide the information as telemetry data, which can be used by the telemetry module to determine the crane states, for example the load hook position and/or the jib alignment.

Alternatively or additionally, for determining the position and/or orientation of one or more crane elements, the crane sensor system may comprise one or more position and/or orientation sensors, which may be mounted on one or more crane elements. In particular, the crane sensor system can comprise one or more location and/or position sensors, for example in the shape of a GPS module on one or more crane elements such as a tower, a jib, a counter jib, a trolley or a load hook, in order to be able to detect the position of the respective crane element in absolute coordinates.

Alternatively or additionally, the crane sensor system may also comprise inertial and/or position sensors for detecting, for example, a load hook position, wherein such position and/or inertial sensors may, for example, be provided on a trolley or a pay-off point of the hoist cable or on the load hook itself or on several of the crane elements. For example, an IMU can be used on the load hook to detect or determine the load hook position using a sensor system.

In a further development of the invention, however, other crane states can also be detected by sensors in addition to the position and/or alignment data. For example, one or more of the following sensor systems may be provided or mounted on the crane, for example to detect weather or climate and/or crane environment data: a temperature sensor, a humidity sensor, a rain or moisture sensor, a salinity sensor and/or a UV light dosimeter. Alternatively or additionally, an surroundings sensor system can also be provided on the crane for detecting objects in the vicinity of the crane, wherein such an surroundings or environment sensor system can, for example, comprise a light detection module, in particular a laser scan module. For example, a Lidar module can be provided for detecting surrounding objects in the crane surroundings or at a construction site using laser light.

Alternatively or additionally, the surroundings sensor system can also have a radar module for detecting surrounding objects using radar waves.

The imaging sensor unit may comprise one or more cameras and/or one or more other imaging sensors, in particular pixel-based sensors, wherein, for example, a line scan camera and/or a matrix camera and/or a CCD sensor and/or a CMOS sensor may be provided.

In this case, one or more imaging sensor units may be mounted on the jib of the crane and/or on the tower of the crane and/or on another structural component of the crane preferably in an upper half of the overall height of the crane.

In order to enable a meaningful data link between the image data of the at least one imaging sensor unit and the crane state data of the crane state determination device, the device can also comprise a timer which provides the associated time data for the respective image data detected from the construction site and the respective crane state data determined. For example, the timer may comprise a real-time clock, the time data of which is linked to the image data of the construction site and the crane status data, for example stored in a linked manner, and/or used by the tuple device to chronologically form the context-sensitive tuples from the image data of the construction site and the crane status data.

The timer can also be used to initiate the consolidation of the image data and the crane status data at predetermined time intervals or in certain cycles, in particular to cyclically trigger the tuple formation and/or provision.

In this case, the timer can be part of the computing unit or provided externally and connected to it.

The computing unit can advantageously be provided with several interfaces in order to be able to receive in parallel at least the image data of the at least one imaging sensor system and the telemetry and/or sensor data for the crane states to be determined and to provide the determined context-sensitive tuples to other devices.

In particular, the computing unit may comprise at least one image data interface, at least one crane state interface and at least one tuple interface, wherein several access interfaces may also be provided for simultaneous access by several users.

Advantageously, the computing unit comprises interfaces of different types in order to be able to connect different sensor units and/or different terminal devices and/or different additional modules. For example, interface software can be provided by means of which end-user devices such as tablets or smartphones can be connected, on which special system applications can be installed in order to further process or evaluate the tuple data provided or, conversely, to input determined construction process data. This allows construction site participants such as a crane operator or ground personnel to communicate with the device and provide the necessary input.

Advantageously, one or more programmable interfaces can be provided to enable device and/or user-specific configuration.

In a further development of the invention, dedicated interfaces can be provided for different devices and/or units to be connected, which the respective device or unit does not have to share with other devices or construction sites. The respective interface can be available at full power exclusively to the module connected to it.

In particular, the at least one imaging sensor unit can be connected to the computing unit via a dedicated interface, wherein, in the case of several imaging sensor units, each sensor unit can also be connected via a respective dedicated interface. This means that, in particular, high-volume or data-rich video streams can also be received at the computing unit without any loss of performance or delays due to possible bottlenecks in data transmission in network components such as switches.

Other sensor systems for determining crane status data can also be connected to the computing unit via a dedicated interface.

Alternatively or additionally, a dedicated interface can also be provided for supplying the telemetry data to the computing unit.

End user devices that can be connected to the computing unit, such as smartphones or tablets, can advantageously be connected via standard interfaces and/or communicate with each other using standardized transmission technology. Advantageously, a data network, for example an Ethernet data network, in the form of an IEEE 802.3 network in particular, can be provided to enable end user devices and/or system modules to communicate with each other.

Advantageously, the one or more sensor units can be supplied with power via the data network, for example by means of PoE or PoE+, i.e. Power over Ethernet.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a schematic representation of the components of a device for documenting a construction site according to an advantageous embodiment of the invention, wherein, on the one hand, the components of the device provided on a crane and, on the other hand, the components of a construction site control system which can be connected via the Internet and communicate therewith are shown.

FIG. 2 is an activity and data flow diagram showing the activity of the various components of the device of FIG. 1 and the data flow between the components.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

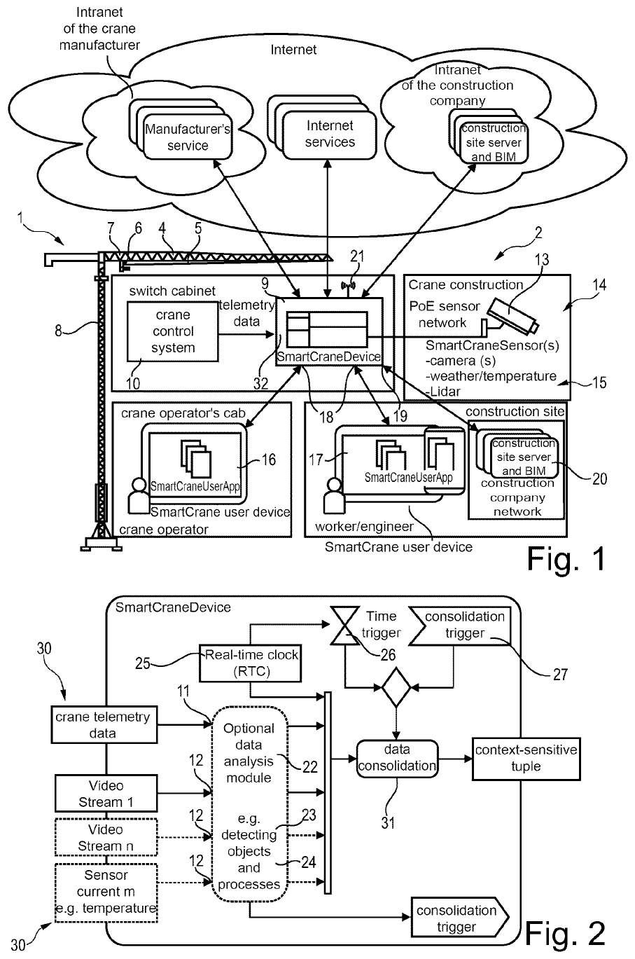

As FIG. 1 shows, the documentation device 2 can be provided on or connected to a crane 1, which can be configured as a tower crane, wherein other crane types such as a telescopic boom crane with a luffed jib can also be provided. It is advantageous to use a crane 1 with sufficient height to provide an overview of the construction site. As FIG. 1 shows, such a crane 1 can comprise a jib 4 from which a load hook 6 descends via a hoist cable 5, wherein the hoist cable 5 can descend, for example, from a trolley 7 which can be moved along the jib 4. In this case, the jib 4 can sit on a tower 8 and can be pivoted relative to or with the tower 8 about an upright axis.

The documentation device 2 comprises an electronic computing unit 9, which comprises one or more processors, for example in the form of microprocessors, and one or more program memories for storing program modules, which can control the at least one processor and/or be processed by the processor and/or influence data processing carried out by the processor.

Advantageously, the computing unit 9 is configured to be modular in order to be able to connect or import various hardware components and/or software modules, for example in the form of apps, in order to be able to adjust the function and mode of operation of the computing unit 9 to the respective documentation task and/or the respective detection devices present.

In particular, various software modules can be installed on the computing unit 9 in order to be able to use the documentation device 2 in various configurations for partially or fully automated detection of objects at a construction site surrounding the crane 1 and/or detection of the construction processes taking place there.

The computing unit 9 advantageously has various interfaces in order to be able to receive and process data streams from various sensor units and data streams from the electronic crane controller 10. In this case, the crane controller 10 can be a control unit known per se for monitoring and controlling the crane operation and/or crane components, wherein the crane controller 10 can, for example, control crane drives such as a slewing gear drive, a trolley drive, a lifting mechanism drive, for example dependent on control commands that are input by a crane operator at the control stand via corresponding input means. Alternatively or additionally, the crane controller 10 can also monitor various crane functions, such as load monitoring, and take into account data from crane sensors such as a lifting load sensor system and a load-out sensor system.

Advantageously, the computing unit 9 can each have a dedicated telemetry data interface 11 for receiving telemetry data from the crane controller 10 and/or a dedicated sensor interface 12 for receiving sensor data from one or more sensor units.

As FIG. 2 illustrates, a separate dedicated sensor interface can also be provided for different sensor systems in this case so that there is no bottleneck for importing the possibly extensive sensor data streams. In particular, such a dedicated sensor interface 12 may be provided at least for each imaging sensor unit 13 that transmits an image data stream to the computing unit 9.

One or more imaging sensor units 13, which may for example each have a camera and/or a pixel matrix-type sensor module, are mounted on the crane 1, wherein an imaging sensor unit 13 may preferably be mounted on the jib 4 and/or on the trolley 7 and/or on the load hook 6 and/or on the tower 8, wherein the imaging sensor unit may preferably be directed towards the crane surroundings or the construction site on which the crane 1 is set up, in order to observe the construction site and provide a video stream of the construction site.

As FIG. 1 shows, the sensor system 14 of the documentation device 2 can have further sensor units 15 for detecting further crane state and/or crane surroundings parameters, for example in the shape of a weather sensor and/or temperature sensor and/or an surroundings sensor, for example in the shape of a lidar sensor, wherein other sensor units such as radar detection devices for detecting objects in the crane surroundings or at a construction site can also be provided. Other sensor units such as transponders or RFID readers can also be provided to detect data from objects at a construction site.

The sensor units 13, 15 of the sensor system 14 can communicate wired or also wirelessly with the respective sensor interface 12. The same applies to the telemetry data transmission, which can be wireless or wired from the crane controller 10 to the computing unit 9.

Radio data transmission can take place in WiFi format, LTE format or the format, for example.

As FIG. 1 also shows, further end-user devices can be connected to the central computing unit 9 of the documentation device 2 due to the modular design, which users can use at a construction site 1. For example, an end-user device 16 of a crane operator and/or an end-user device 17 of a ground crew member can be connected to the computing unit 9 via a respective interface in order to communicate with it. For example, smartphones or tablets can be used as end-user devices 16, 17, on which a software module can be installed, which can be adjusted to the computing unit 3 and its functions and/or can share certain functions with the computing unit 3 and/or can retrieve certain function and information packets from the computing unit 3 and/or can transmit them to the computing unit 3.

The end-user devices 16, 17 can each be connected via an end-user interface 18 of the computing unit 9.

As FIG. 1 also shows, the computing unit 9 can also comprise a network interface 19 in order to be connected to a construction site server and/or a BIM server 20, in which a construction site information model can be made available in the form of a database, and/or to a network of a construction company.

However, the documentation device 2 can also communicate with other system participants away from the construction site by remote data transmission, in particular via the Internet, and can have a communication device 21 for this purpose, which can, for example, have a mobile radio receiver or also a fixed network connection for data transmission via mobile radio or fixed network.

For example, a crane manufacturer can communicate with the computing unit 9 of the documentation device 2 via the communication device 21. Alternatively or additionally, an information server provided on the Internet can be connected. Alternatively or additionally, a server specific to the construction project, for example in the form of a BIM server with design data for the construction project, can also communicate with the computing unit 9 via the Internet or the communication device 21.

As FIG. 2 shows, the computing unit 9 can also be modularly expanded or reconfigured within the communication interfaces 11, 12, 18, 19 by installing special software modules on the computing unit 9. This can comprise, in particular, a data analysis module 22 for analyzing the telemetry data fed in by the crane controller 10 and/or the sensor data provided by the sensor system 14, wherein such a data analysis module 22 can comprise, for example, a software app that can be installed on the computing unit 9.

Alternatively or in addition to such a data analysis module 22, an object identification module 23 can also be installed on the computing unit 9, in particular, for example in the form of a software app, in order to identify objects detected by the imaging sensor unit 13 and/or another sensor unit 15 in the surroundings of the crane 1 or at a construction site. Such an object identification module 23 may, for example, comprise an image evaluation device to identify an object on the basis of determined contours in the construction site images, possibly with the aid of further data that can be provided from the BIM server 20. Alternatively or additionally, depending on the design of the sensor system, another type of object identification can also take place, for example using read-out transponder data.

Alternatively or additionally, a process identification module 24 can also be installed on the computing unit 9, for example in the form of a software module, in order to be able to automatically identify certain construction site processes, for example excavation work, which can be identified, for example, by means of detected machine activities such as excavation work or by means of an image evaluation module. The process identification module 24 can also access data from the BIM server in addition to the sensor data from the sensor system 14.

As FIG. 2 illustrates, the computing unit 9 is also supplied with time data by a timer 25, for example in the form of a real-time clock, with the aid of which the computing unit 9 can assign the supplied image data streams and sensor data streams and/or telemetry data streams to one another in terms of time and classify them chronologically.

The time data of the timer 25 can also be supplied to a cycle trigger 26 in order to cyclically or possibly also continuously trigger or accomplish the tuple formation and to form and provide the context-sensitive tuples the at the beginning from the supplied data streams and possibly sensor system and/or telemetry data derived therefrom.

As FIG. 2 illustrates, data processing and tuple formation can also be triggered by a trigger device 27, which can provide a trigger signal depending on certain events and/or manual actuation, for example.

As can be seen from the above description, the documentation device 2 can solve or at least mitigate the problems of conventional systems outlined at the beginning by using the exposed position of tower cranes and the possible views of cranes 1 onto the construction site to enable a holistic recording of the construction site situation. In this case, the actual situation is ensured by means of the wide range of information that can be provided by at least one imaging sensor unit 13 and the status data of the crane, in particular telemetry data from the electronic crane controller. Missing status data of the crane can be obtained or provided via additional physical sensor systems 15, which can be integrated into the system via a standard network interface.

On the one hand, the computing unit 9 can be used to transmit the detected information to processing systems both on the Internet and in the intranets of the crane manufacturer or also of participating construction companies. If the crane 1 does not have a suitable communication unit, such as WLAN, LTE, the, the computing unit 9 can be extended with appropriate communication modules.

The computing unit 9 also has interface software. This software can be used to integrate end-user devices 16, 17 such as tablets or smartphones, on which a special system application or user app is installed, into the system.

This makes it possible for those involved in the construction work, such as the crane operator or also ground personnel (foreman, slinger etc.), to communicate with the system and make the necessary inputs. In addition, it is possible in particular to display the system status and the current detected status of the construction site on the terminal devices 16, 17.

In this case, the documentation device 2 includes various specific aspects.

In particular, the system concept plays a substantially important role. This enables comprehensive and continuous construction site documentation thanks to a modular and flexible structure that can be adapted to the respective construction site situation. With corresponding software modules, which can be installed on the computing unit 9, the system can also be used for the (partially) automated detection of objects and processes as required.

The smallest embodiment of the system can consist in particular of the computing unit 9, a sensor unit with optical sensor 13 and an interface for telemetry data. Possible extensions include additional sensor units 15 and also data transmission to remote networks and to mobile end devices 16, 17 at a construction site via radio (e.g. Wi-Fi, LTE, the) or wired. In this case, at least one extension for data transmission may be recommended in order to be able to retrieve the information collected about the construction site. Dedicated network interfaces 11, 12 are preferably available on the computing unit 9 for receiving data streams from the sensor unit(s) 13, 14, 15 (such as video streams) in order to avoid possible bottlenecks during data transmission in network components such as a switch.

If the crane 1 being used does not have a suitable or usable interface for the transmission of telemetry data, this data can also be determined by a corresponding sensor unit 14, 15, e.g. by means of positioning technologies such as GPS or also position and attitude sensors for determining the hook position. Other applications for additional sensor units 15 can be the detection of environmental conditions, such as weather data.

Another aspect is the consistent use of standardized interfaces and transmission technologies. The individual system modules are preferably connected to each other in an Ethernet data network such as IEEE 802.3. The power supply for the sensor units 13, 15 can be provided by means of “Power over Ethernet” (PoE/PoE+and future standards such as IEEE 802.3). Any standardized data video streams can be processed in the computing unit 9, such as RTSP or GigE Vision.

For data transmission, if the crane 1 does not already have a corresponding modem unit, the computing unit 9 can be extended with a required transmission module 21. Radio standards such as Wi-Fi (IEEE 802.11), LoRa, LTE, the and future standards can be used for this purpose.

The construction site documentation can be carried out in particular by consolidating the available information from the sensor units 13, 15 and telemetry data continuously or in previously defined time intervals or via triggers and providing it as context-sensitive tuples for further use, see FIG. 2.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A sensor system for detecting crane construction site information comprising:
an electronic computing unit for processing:
detected construction site images from an imaging sensor unit; and
determined crane states from a crane state determination unit;
wherein the electronic computing unit comprises a tuple unit for determining and providing context-sensitive tuples for construction site documentation from the detected construction site images and the determined crane states.

2. A device for documenting a construction site with a crane associated with the sensor system according to claim 1, wherein:
the crane state determination unit comprises a telemetry data module for:
retrieving and/or receiving telemetry data from an electronic crane controller; and
determining the crane states from the telemetry data transmitted by the electronic crane controller; and
the tuple unit is configured to determine the context-sensitive tuples in consideration of the telemetry data transmitted by the electronic crane controller.

3. The device according to claim 2, wherein the sensor system is configured for sensory detection of at least a part of the determined crane states.

4. The device according to claim 3, wherein the sensor system further comprises a position and/or orientation sensor unit for determining the position and/or orientation of a crane element of the crane; and
wherein the tuple unit is further configured to determine the context-sensitive tuples in consideration of the position and/or location of the crane element.

5. The device according to claim 4, wherein the position and/or orientation sensor unit comprises a position and/or orientation sensor positioned on the crane element:
wherein the crane element is selected from a group consisting of a jib of the crane, a load hook of the crane and a trolley of the crane; and
wherein the tuple unit is further configured to determine the context-sensitive tuples in consideration of the position and/or orientation of the crane element on which the position and/or orientation sensor is positioned.

6. The device according to claim 2, wherein the electronic computing unit has separate interfaces for connection with the electronic crane controller and the imaging sensor unit.

7. The device according to claim 2, wherein the electronic computing unit has a dedicated sensor interface for the imaging sensor unit.

8. A system for documenting a construction site with a crane comprising:
a computing unit comprising:
one or more interfaces configured for data communication with:
one or more imaging sensors positioned to image at least a portion of the construction site; and
one or more position and/or orientation sensors positioned on one or more crane elements of the crane;
one or more processors; and
memory comprising instructions that, when executed by the one or more processors, cause the computing unit to:
detect construction site images of the construction site from one or more of the imaging sensors;
determine crane states of the crane from:
telemetry data from one or more crane controllers associated with the crane; and
position and/or orientation data of one or more of the crane elements from one or more of the position and/or orientation sensors; and
process the detected construction site images and the determined crane states with a tuple unit for determining and providing context-sensitive tuples for construction site documentation from the detected construction site images and the determined crane states.

9. The system according to claim 8, wherein the computing unit has a structure capable of being expanded in a modular manner and is configured to share documentation-relevant functions for documenting the construction site with at least one expansion module; and
wherein the at least one expansion module is configured to be selectively installed on a separate, mobile end-user device connectable to the computing unit.

10. The system according to claim 2, wherein the at least one expansion module comprises an object identification module and/or a process identification module for identifying objects or processes at the construction site on which the crane is mounted from the detected construction site images and the determined crane states.

11. The system according to claim 2, wherein the at least one expansion module comprises a data evaluation module for evaluating the construction site images and the crane states.

12. The system according to claim 8, wherein the one or more interfaces comprise a plurality of end-user interfaces for parallel connection of a plurality of end-user devices which are used at the construction site.

13. The system according to claim 8, wherein the one or more interfaces comprise at least one network interface for connecting a construction site server provided at the construction site on which the crane is mounted.

14. The system according to claim 8, wherein the one or more interfaces comprise an interface software for integrating end-user devices of different types on which an extension module is installed for using and/or influencing documentation-relevant functions for documenting the construction site.

15. The system according to claim 8 further comprising a communication device connected to the computing unit;
wherein the communication device is configured for remote data transmission and remote communication with at least one server installed away from the construction site.

16. The system according to claim 8, wherein the one or more interfaces are further configured for data communication with at least one temperature sensor unit and/or at least one weather sensor unit; and
wherein the tuple unit is configured to form the context-specific tuples in consideration of the temperature and/or weather data of the at least one temperature and/or weather sensor unit.

17. The system according to claim 8, wherein the one or more interfaces are further configured for data communication with at least one environment detection unit comprising a laser and/or radar sensor unit for detecting objects in the surroundings of the crane; and
wherein the tuple unit is configured to form the context-sensitive tuples in consideration of the detected environment data of the environment sensor data.

18. The system according to claim 8, wherein the one or more interfaces are further configured for data communication with at least one timer for providing time data; and
wherein the tuple unit is configured to form the context-sensitive tuples in chronological order in consideration of the time data.

19. The system according to claim 8, wherein the one or more interfaces are further configured for data communication with a data network via which one or more of the sensors are connected; and
wherein at least one of the sensors is configured to be supplied with power via a data network connection to the data network.

20. (canceled)

21. A device for documenting a construction site with at least one crane, with the sensor system according to claim 1, which has at least one of the imaging sensor units mounted on the crane for detecting the construction site images, the crane state determination device for determining the crane states, and the electronic computing unit for processing the detected construction site images and the determined crane states, wherein the electronic computing unit comprises the tuple unit being a tuple device for determining and providing the context-sensitive tuples for the construction site documentation from the detected construction site images and the determined crane states.

22. The device according to claim 21, wherein the crane state determination device comprises at least one of:
a telemetry data module for retrieving and/or receiving telemetry data from an electronic crane controller and determining the crane states from the telemetry data transmitted by the crane controller, and the tuple device is configured to determine the context-sensitive tuples in consideration of the telemetry data transmitted by the electronic crane controller; or
a crane sensor system for sensory detection of at least a part of the crane states.

23. The device according claim 22, wherein:
the crane sensor system comprises at least one position and/or orientation sensor unit for determining the position and/or orientation of at least one crane element of the crane;
the position and/or orientation sensor unit comprises at least one position and/or orientation sensor on a jib of the crane and/or on the load hook of the crane and/or on a trolley for detecting the position and/or orientation of the jib and/or the trolley and/or the load hook; and
the tuple device is configured to determine the context-sensitive tuples in consideration of the position and/or orientation of the jib and/or the trolley and/or the load hook.

24. The device according to claim 22, wherein the computing unit has separate telemetry and sensor interfaces for connection of the electronic crane controller of the crane on the one hand and for connecting the at least one imaging sensor unit and/or other sensor units on the other hand.

25. The device according to claim 22, wherein the computing unit comprises at least one dedicated sensor interface for the at least one imaging sensor unit.

26. The device according to claim 25, wherein the computing unit comprises at least one further dedicated sensor interface for at least one further sensor unit and at least one further dedicated telemetry and sensor interface for connecting to the electronic crane controller.

27. The device according to claim 22, wherein:
the computing unit has a structure able to be expanded in a modular manner and is configured to share documentation-relevant functions for documenting the construction site with at least one expansion module;
at least one of the expansion modules is selectively installed on a separate, mobile end-user device, which can be connected to the computing unit via an end-user interface, or on the computing unit itself;
at least one of the expansion modules comprises an object identification module and/or a process identification module for identifying objects or processes at the construction site on which the crane is mounted from the detected construction site images and the determined crane states; and
at least one of the expansion modules comprises a data evaluation module for evaluating the construction site images of the at least one imaging sensor unit and for evaluating the crane states of the crane state determination device.

28. The device according to claim 22, wherein the computing unit comprises at least one of:
a plurality of end-user interfaces for parallel connection of a plurality of end-user devices which are used at a construction site, wherein the end-user devices are connected via interfaces with Ethernet capability;
at least one network interface for connecting a construction site server provided at the construction site on which the crane is mounted; or
an interface software for integrating end-user devices of different types on which an extension module is installed for using and/or influencing documentation-relevant functions for documenting the construction site.

29. The device according to claim 22, wherein a communication device connected to the computing unit is provided for remote data transmission and remote communication with at least one server installed away from the construction site.

30. The device according to claim 22, wherein at least one of:
a temperature sensor unit is provided and the tuple device is configured to form the context-specific tuples in consideration of temperature data of the temperature sensor unit;
a weather sensor unit is provided and the tuple device is configured to form the context-specific tuples in consideration of weather data of the weather sensor unit;
at least one environment detection unit comprising a laser and/or radar sensor unit for detecting objects in the surroundings of the crane is mounted on the crane and the tuple device is configured to form the context-sensitive tuples in consideration of environment data of the at least one environment detection unit; or
at least one real-time clock is provided for providing time data and the tuple device is configured to form the context-sensitive tuples in chronological order in consideration of the time data.

31. The device according to claim 22, wherein provision is made for a power supply device for supplying power to the sensor units on the crane, the power supply device having an Ethernet module for supplying power to the sensor units via a data network via which the sensor units are connected, and at least one sensor unit mounted on the crane is configured to be supplied with power via a data network connection.

32. A crane comprising the device according to claim 22.
